(19) United States
(12) Patent Application Publication
(10) Pub. No.: US 2015/0283019 A1
(43) Pub. Date: Oct. 8, 2015

(54) TACTILE TRANSDUCER TREATMENT SYSTEM

(71) Applicant: Kugona LLC, Lake Forest, IL (US)

(72) Inventor: Richard A. Feingold, Lake Forest, IL (US)

(73) Assignee: KUGONA LLC, Lake Forest, IL (US)

(21) Appl. No.: 14/679,240

(22) Filed: Apr. 6, 2015

Related U.S. Application Data
(60) Provisional application No. 61/976,328, filed on Apr. 7, 2014.

(51) Int. Cl. A61H 1/00

(52) U.S. Cl. CPC A61H 1/008; A61H 2201/5025; A61H 2201/5048

(57) ABSTRACT

A tactile transducer treatment system includes a foundation that is configured to support a mattress. At least one tactile transducer device is mounted to the foundation. A processing system is coupled to the at least one tactile transducer device. A memory system is coupled to the processing system and includes instruction that, when executed by the processing system, cause the processing system to provide a treatment engine. The treatment engine is configured to drive the at least one tactile transducer using an audio file that includes a binaural audio soundtrack and an isochronic tone soundtrack to produce a tactile response in the foundation. That tactile response has been found to be beneficial in the treatment of a number of patient conditions including autism, attention deficit disorder, attention deficit hyperactivity disorder, post-traumatic stress disorder, bed wetting, and/or a variety of sleep disorders.

### CROSS REFERENCE TO RELATED APPLICATIONS

This application claims priority of U.S. Provisional Patent Application Ser. No. 61/976,328 filed Apr. 7, 2014, the disclosure of which is incorporated herein by reference in its entirety.

### BACKGROUND

The present disclosure relates generally to patient treatment, and more particularly to tactile transducer treatment system for treating a variety of patient conditions.

One example of a patient condition that is subject to a variety of problems for which new and innovative treatments are needed is autism. Autism is a disorder of neural development characterized by impaired social interaction and verbal and non-verbal communication, as well as by restricted, repetitive or stereotyped behavior. Autism affects information processing in the brain by altering how nerve cells and their synapses connect and organize, but how this occurs is not well understood. Autism is known to be associated with a number of secondary conditions. For example, about two-thirds of autism sufferers are affected with sleep disorders at some point in their childhood. Those sleep disorders most commonly include symptoms of insomnia such as difficulties in falling asleep, frequent nocturnal awakenings, and early morning awakenings. Such sleep disorders are associated with further problems with autistic children that include difficult behaviors and family stress, and those are often the focus of clinical attention over and above the primary autism diagnosis. Conventional treatments for sleep disorders in autistic children include rocking the autistic child, providing the autistic child sleep enhancing supplements such as melatonin, and proving heavy (e.g., lead) blankets for use by the autistic child that are thought to enhance sleep. While providing some degree of success, such conventional methods have not been entirely satisfactory in treating autism-related sleep disorders.

Accordingly, it would be desirable to provide an improved treatment system for patients suffering from autism.

### SUMMARY

According to one embodiment, a tactile transducer treatment system includes a foundation that is configured to support a mattress; at least one tactile transducer device that is mounted to the foundation; a processing system that coupled to the at least one tactile transducer device; a memory system that is coupled to the processing system and that includes instructions that, when executed by the processing system, cause the processing system to provide a treatment engine that is configured to: drive the at least one tactile transducer using an audio file that includes a binaural audio soundtrack and an isochronic tone soundtrack an audio file that includes a binaural audio soundtrack and an isochronic tone soundtrack, wherein the driving of the at least one tactile transducer produces a tactile response in the foundation.

### BRIEF DESCRIPTION OF THE DRAWINGS

FIG. 1a is a top perspective view illustrating an embodiment of a foundation.

FIG. 1b is a bottom perspective view illustrating an embodiment of the foundation of FIG. 1a.

FIG. 2 is a perspective view illustrating an embodiment of a tactile transducer device.

FIG. 3 is a bottom perspective view illustrating an embodiment of a tactile transducer treatment system including a plurality of the tactile transducer devices of FIG. 2 mounted to the foundation of FIGS. 1a and 1b.

FIG. 4 is a perspective view illustrating an embodiment of a computing device.

FIG. 5 is a schematic view illustrating an embodiment of a tactile transducer treatment system.

FIG. 6 is a flow chart illustrating an embodiment of a method for treating a patient.

FIG. 7 is a perspective view illustrating a patient being treating using the tactile transducer treatment system of FIG. 5 and the method of FIG. 6.

### DETAILED DESCRIPTION

A wide variety of patient conditions involve sleep disorders symptoms and/or are otherwise associated with the inability to relax. For example, as discussed above, a majority of autistic children suffer from the inability to fall asleep and/or stay asleep. It has been discovered that the systems and methods of the present disclosure provide autistic children an enhanced ability to fall asleep and stay asleep throughout the night. Furthermore, as discussed below, the systems and methods of the present disclosure have been found and/or are expected to provide similar benefits in treating a wide variety of patient conditions related to sleep and/or relaxation, including the inability to fall asleep, stay asleep, and/or relax that is associated with attention deficit disorder (ADD), attention deficit hyperactivity disorder (ADHD), post-traumatic stress disorder (PTSD), and muscular disorders such as Parkinson's Disease and Cerebral Palsy; as well the inability to control the bladder associated with bed wetting disorders. Further still, the relaxation provided to patients using the systems and methods of the present disclosure has been found to be beneficial in massage procedures provided to massage patients. While a number of example applications of the systems described herein to various patient conditions are provided below, one of skill in the art in possession of the present disclosure will recognize that the systems and methods described herein will be beneficial to a variety of other patient conditions known in the art and thus will fall within its scope.

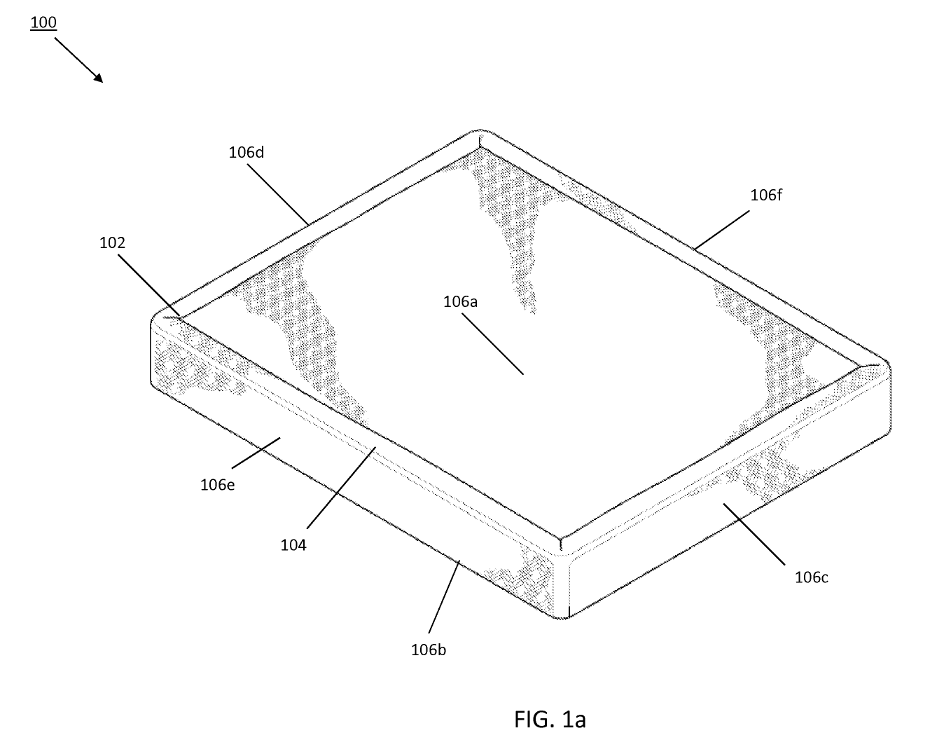

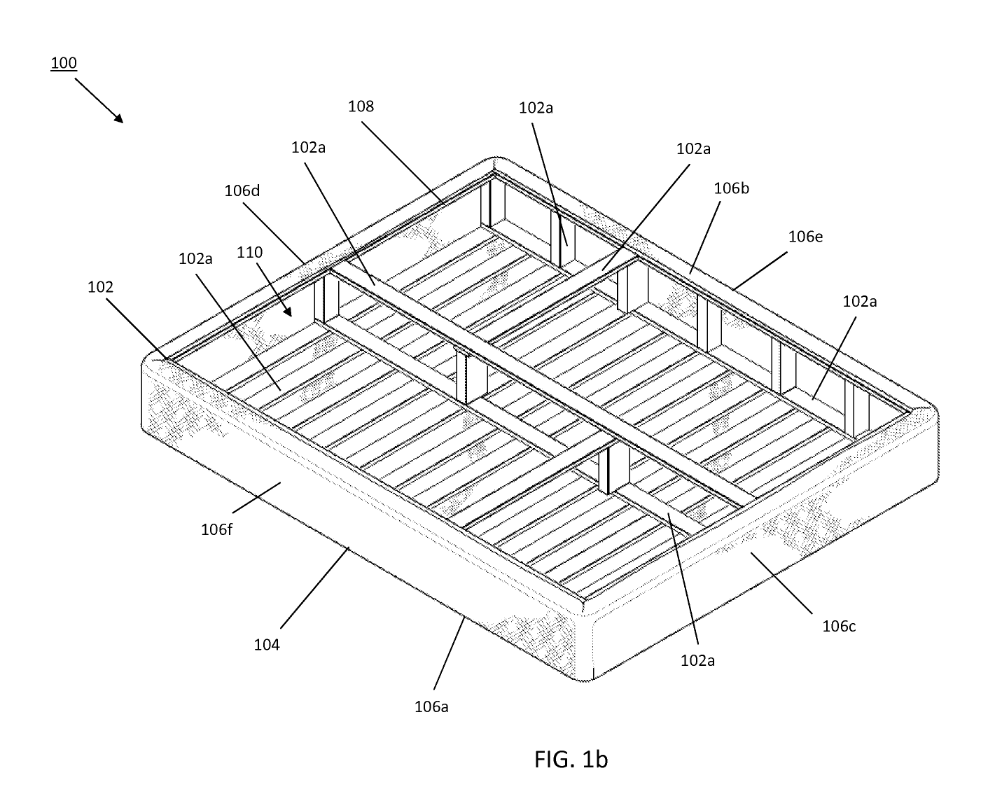

Referring now to FIGS. 1a and 1b, an embodiment of a foundation 100 that is part of a tactile transducer treatment system, discussed in further detail below, is illustrated. In the illustrated embodiment, the foundation 100 is a bed mattress foundation that is configured to support a bed mattress used for sleeping. However, as discussed in further detail below, other types of foundations may be used to provide the tactile transducer treatment system discussed below including, for example, massage table foundations, seat (e.g., recliner seat) foundations, and/or a variety of other foundations known in the art. The foundation 100 includes a base 102 that is provided using a plurality of foundation elements 102a that, in the embodiments illustrated and discussed below, may include solid wood foundation elements that are mounted to each other to provide the base 102 in a desired shape and size. A foundation cover 104 is provided over a portion of the foundation elements 102a to provide the foundation 100 with a top surface 106a, a bottom surface 106b located opposite the base 102 from the top surface 106a, a front surface 106c extending between the top surface 106a and the bottom surface 106b, a rear surface 106d located opposite the base 102 from the front surface 106c and extending between the top surface 106a and the bottom surface 106b, and a pair of side surfaces 106e and 106f that are located opposite the base 102 from each other and that extend between the top surface 106a, the bottom surface 106b, the front surface 106c, and the rear surface 106d. As can be seen in FIG. 1b, the bottom surface 109b provides a perimeter entrance 108 adjacent a foundation channel 110 that is defined by the base 102 and located between the top surface 106a, the bottom surface 106b, the front surface 106c, the rear surface 106d, and the side surfaces 102e and 102f.

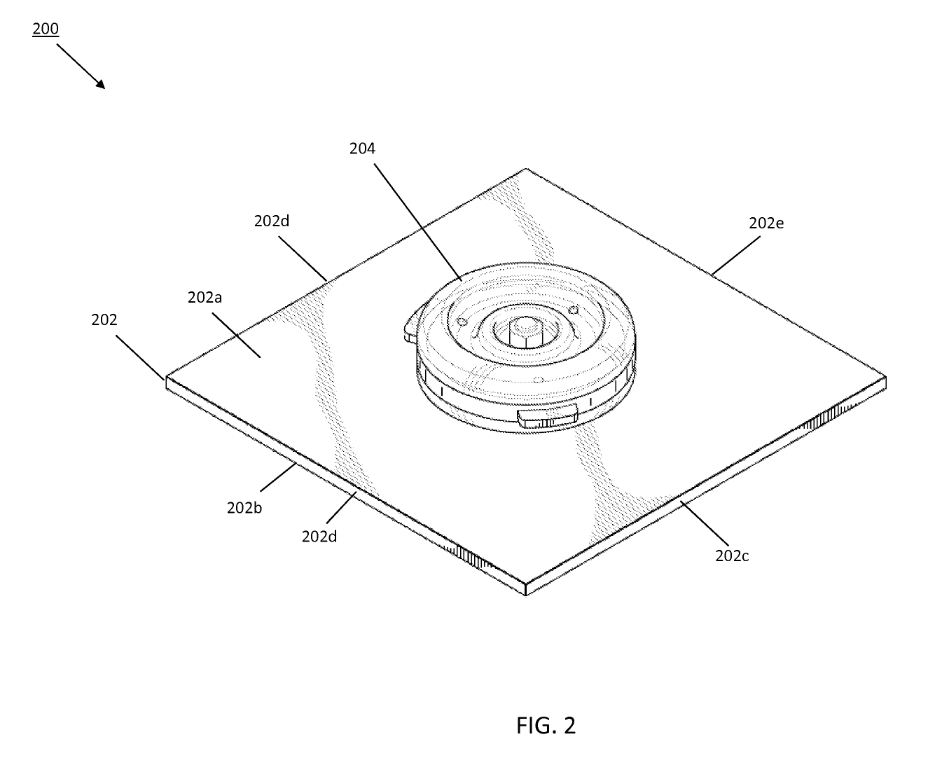

Referring now to FIG. 2, an embodiment of a tactile transducer device 200 is illustrated. The tactile transducer device 200 includes a base 202 having a top surface 202a, a bottom surface 202b located opposite the base 202 from the top surface 202a, a front edge 202c extending between the top surface 202a and the bottom surface 202b, a rear edge 202d located opposite the base 202 from the front edge 202c and extending between the top surface 202a and the bottom surface 202b, and a pair of side edges 202e and 202f that are located opposite the base 202 from each other and that extend between the top surface 202a, the bottom surface 202b, the front edge 202c, and the rear edge 202d. A tactile transducer 204 is centrally located and mounted to the top surface 202a of the base 202. In the illustrated embodiment, the tactile transducer 204 houses one or more weighted elements and a voice coil that is configured to be driven by amplifier (discussed in further detail below) and, as such, the tactile transducer 204 includes one or more connections (not illustrated) that are configured to couple to a wire, cable, or other transmission medium and transmit drive signals from that amplifier. While a specific tactile transducer device has been described, other types of tactile transducer devices such as, for example, linear actuators that include piston-like electromagnetic devices, are envisioned as falling within the scope of the present disclosure. In an embodiment, the tactile transducer device 200 is a tactile transducer device available from Kugona LLC of Lake Forest, Ill. In experimental embodiments, tactile transducer devices were used that included a magnetic weighted element with a diameter of 38 mm and a weight of 113.4 grams. The magnetic weighted element was connected to a voice coil with a diameter of 44 mm and an impedance of 4 ohms. The tactile transducer devices had a weight of 368.5 grams without mounting hardware, and a power rating of 50 watts root mean square (RMS) (dependent on frequency and duty cycle).

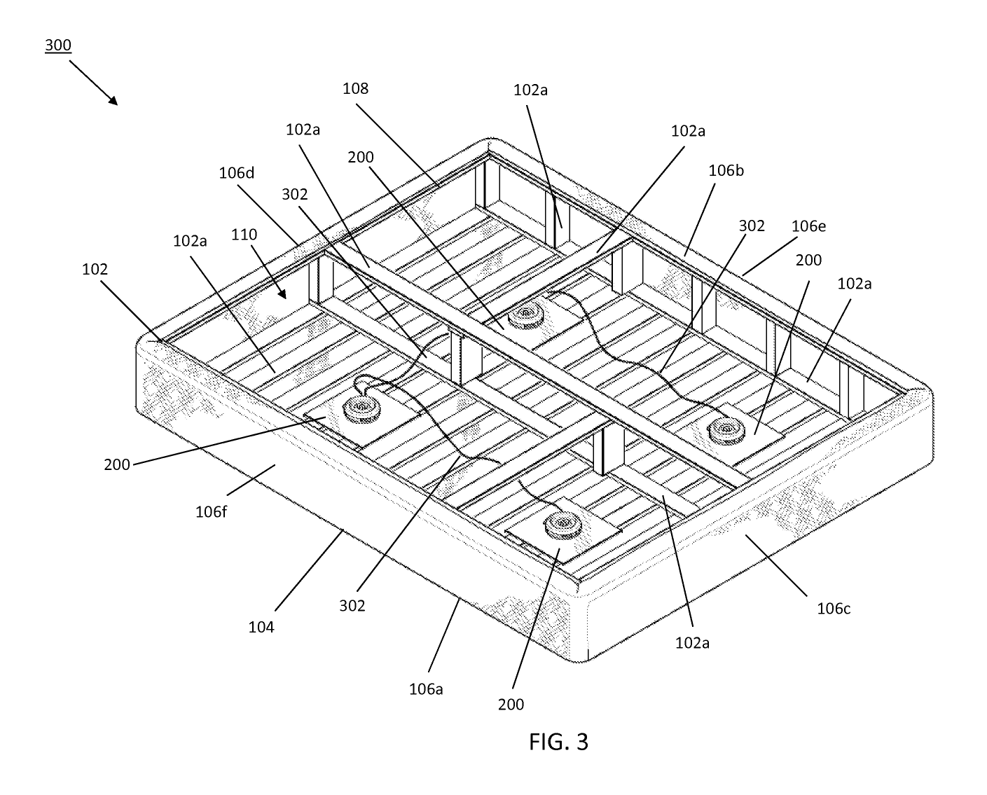

Referring now to FIG. 3, an embodiment of a tactile transducer treatment system 300 is illustrated. In the embodiments discussed below, the tactile transducer treatment system 300 includes a plurality of the tactile transducer devices 200, discussed above with reference to FIG. 2, mounted to the foundation 100 discussed above with reference to FIGS. 1a and 1b. However, different numbers of tactile transducers may be coupled to different types of foundations (e.g., the massage table foundations discussed further herein) while remaining within the scope of the present disclosure. In the illustrated embodiment, four of the tactile transducer devices 200 have been positioned in the foundation channel 110 and mounted to one or more of the foundation elements 102a by positioning the base 202 of each tactile transducer device 200 in the foundation channel 110 adjacent one or more foundation elements, and mounting the base 202 to those one or more foundation elements 102a by, for example, mechanically fastening the base 202 to the foundation elements 102 using screws, bolts, nails, etc., and/or using a variety of other mounting methods know in the art. In the illustrated embodiment, the tactile transducer devices 200 are mounted to the foundation in a spaced-apart orientation from each other, and have been coupled together in series by connecting wires 302 between the one or more connections provided on the tactile transducers 204. The spaced apart orientation of the tactile transducer devices 200 may be provided as illustrated such that each of the tactile transducer devices 200 provides for tactile responses (discussed below) for a different quadrant of the foundation 100. However, as discussed above, other numbers and configurations of tactile transducer devices are envisioned as falling within the scope of the present disclosure.

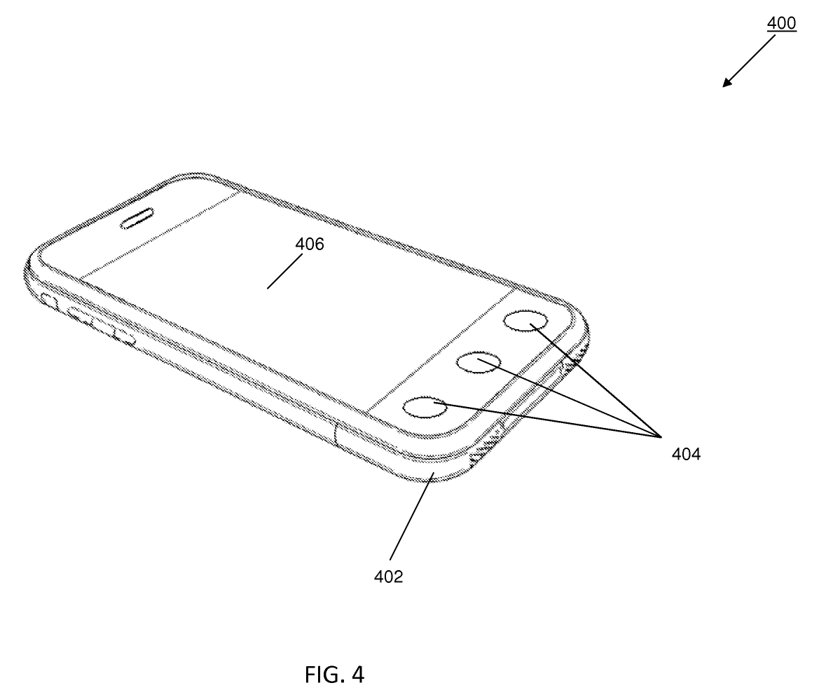

Referring now to FIG. 4, an embodiment of a computing device 400 is illustrated. In the illustrated embodiment, the computing device 400 includes a base 402 having a plurality of input buttons 404 and a display device 406 that includes a touch input display that provides, in combination with the input buttons 404, an input system for the computing device 400. While not illustrated, the base 402 may house a processing system, a memory system, a communications system, a mass storage system, and/or a variety of other computing device subsystems known in the art. In specific embodiments discussed below, the memory system in the computing device 400 may include instructions that, when executed by the processing system, cause the processing system to provide a treatment engine that is configure to perform the functions of the treatment engines discussed below. In some of the embodiments discussed below, the mass storage system stores one or more audio files that may be transmitted to an amplifier, discussed below. While the computing device 400 is illustrated and described as a mobile phone, one of skill in the art in possession of the present disclosure will recognize that a wide variety of computing devices such as, for example, desktop computing devices, laptop/notebook computing devices, tablet computing devices, audio player computing devices, and/or a variety of other computing devices known in the art will fall within the scope of the present disclosure. In addition, while the computing device 400 is described below as being configured to couple to and decouple from the amplifier (e.g., a mobile phone via an audio cable), computing devices that are integrated into the tactile transducer treatment system are envisioned as falling within the scope of the present disclosure.

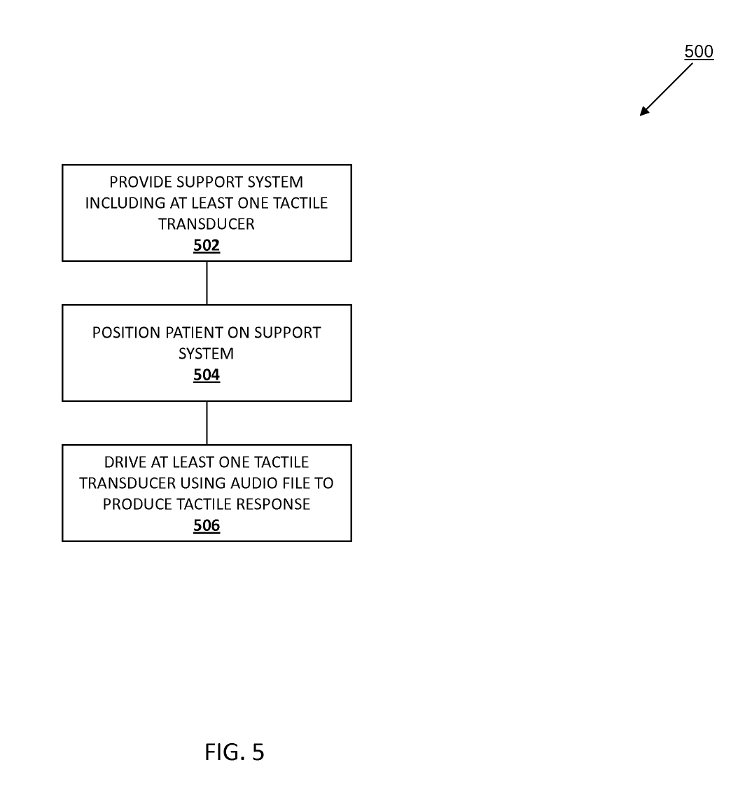

Referring now to FIG. 5, an embodiment of a method 500 for treating a patient is illustrated. As discussed in further detail below, the tactile transducer treatment systems of the present disclosure have been found, when operated according to the method 500, to provide substantial benefits in the treatment of a variety of patient sleep and relaxation related conditions including autism, ADD, ADHD, PTSD, bed wetting, muscular disorders, etc. While a few examples of specific patient conditions are provided below, one of skill in the art in possession of the present disclosure will recognize that the systems and methods of the present disclosure may provide benefits in the treatment of a variety of sleep and/or relaxation symptoms associated with a wide variety of patient conditions while remaining within the scope of the present disclosure.

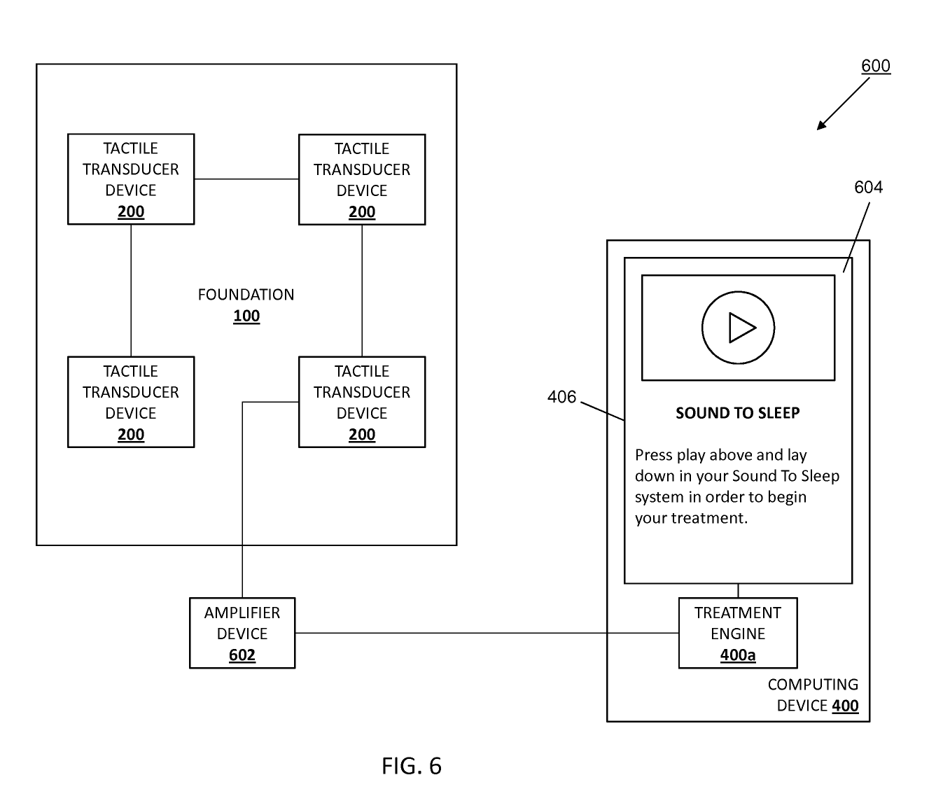

The method begins at block 502 where a support system including at least one tactile transducer is provided. Referring now to FIG. 6, in an embodiment of block 502, a tactile transducer treatment system 600 is provided that includes the foundation 100 discussed above with reference to FIGS. 1a and 1b, the tactile transducer devices 200 discussed above with reference to FIG. 2, and the computing device 400 discussed above with reference to FIG. 4. In the illustrated embodiment, the tactile transducer devices 200 are mounted to the foundation 100 and coupled together in series (e.g., similarly as illustrated in FIG. 4), and one of those tactile transducer devices 200 is coupled to an amplifier 602 (e.g., using a connecting wire similar to the connecting wires 302 illustrated in FIG. 3, using a cable, etc.). In an embodiment, the amplifier 602 may be an amplifier such as, for example, a TSA-50 tactile sound amplifier available from Kugona LLC of Lake Forest, Ill. In experimental embodiments, 3-channel amplifiers were used that two channels for stereo headphone output and one channel for tactile transducer device output. The stereo channels included a gain of 6 decibels, a signal to noise ratio of +/−95 decibels, a total harmonic distortion of +/−0.1%, a frequency response of 50-20,000 KHz, a minimum electromotive force of 450 mV, and a power of 1 V (RMS) at 32 ohms. The tactile transducer device channel included a gain of 47 decibels, a signal to noise ratio of +/−85 decibels, a total harmonic distortion of +/−0.5%, a frequency response of 10-150,000 KHz, a minimum electromotive force of 50 mV, and a power of 50 watts at 4 ohms. The amplifiers exhibited a total power consumption of 90 watts at 4 ohms and 55 watts at 8 ohms.

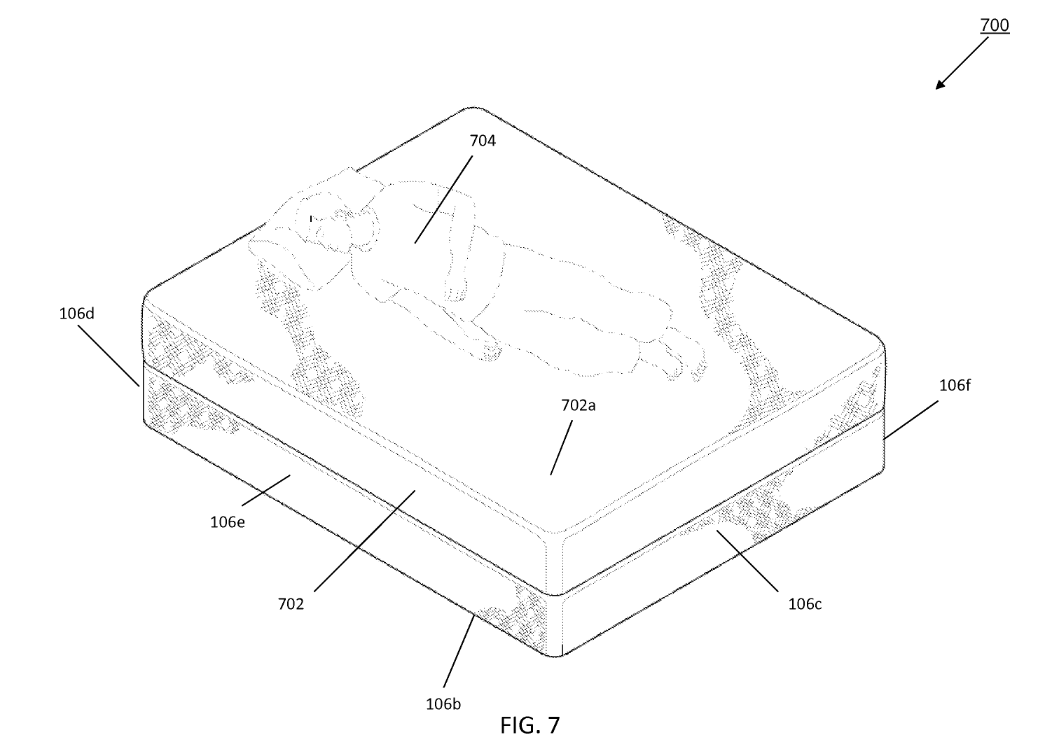

While illustrated as coupled in series, the amplifier 502 and tactile transducer devices 200 may be coupled in parallel and/or in a variety of other configurations while remaining within the scope of the present disclosure. While illustrated as adjacent to and outside the foundation 100, the amplifier 502 may be integrated into the foundation 100 (e.g., positioned in the foundation channel 110 similarly to the tactile transducer devices 200) while remaining within the scope of the present disclosure. In the illustrated embodiment, the amplifier 502 may be coupled to a treatment engine 400a (discussed above) via a cable connected to each of the amplifier 502 and the computing device 400 (e.g., an audio cable), a wireless connection between the amplifier 502 and the computing device 400, and/or using a variety of other methods known in the art. In an embodiment, a mattress (illustrated in FIG. 7) may be provided on the top surface 106a of the foundation 100 to provide the support surface at block 502.

The method 500 then proceeds to block 504 where a patient is positioned on the support surface. Referring to FIG. 7, the tactile transducer treatment system 300/600 is illustrated including a mattress 702 that provides a support surface 702a upon which a patient 704 is positioned. As discussed above, while the foundation 100 is illustrated as a bed mattress foundation, the mattress 702 as a bed mattress, and the patient 704 as a sleeping patient, some embodiments may include massage tables, seats (e.g., recliners), and/or other support surfaces upon which a patient may relax instead of, or in addition to, sleeping. In an embodiment of blocks 502 and 504 of the method 500, the patient 704 may purchase the amplifier 502 and the foundation 100 with mounted tactile transducer devices 200 from a system provider (e.g., Kugona LLC of Lake Forest, Ill.), while providing the mattress 702 from that system provider or a separate mattress provider. The patient may then connect their computing device 400 to the amplifier 502 to provide the tactile transducer treatment system illustrated in FIGS. 6 and 7. However, in other embodiments, the tactile transducer treatment systems 600 and/or 700 may be entirely provided by a system provider and include the foundation 100, tactile transducer devices 200, amplifier 502, computing device 400, and mattress 700 while remaining within the scope of the present disclosure. Furthermore, while in some embodiments below, the patient 704 is discussed as operating the tactile transducer treatment system, in other embodiments, the tactile transducer treatment system may be operated by a treatment administrator or medical professional.

The method 500 then proceeds to block 506 where at least one tactile transducer is driven using an audio file to produce a tactile response. In an embodiment of block 506, the computing device 400 may include an application that allows for the playing of one or more audio files by the computing device 400. For example, the treatment engine 400a in the computing device 400 of FIG. 6 is illustrated as providing, on the display device 406, an audio file play screen 604 that allows the patient 704 (or treatment administrator) to instruct the computing device 400 to execute an audio file on the computing device 400. In response to the instruction to execute the audio file on the computing device 400, the treatment engine 400a transmits the executed audio file data to the amplifier 602. In response to receiving the executed audio file data, the amplifier 602 operates to drive the tactile transducer devices 200 using that executed audio file data. In response to being driven by the amplifier 602, the tactile transducer devices 200 operate to produce a tactile response in the foundation 100 that is transmitted through the mattress 700 to the patient 704. In some embodiments, a plurality of the tactile transducer devices 200 are driven using stereophonic sound techniques, quadrophonic sound techniques, surround sound techniques, and/or in a variety of other multi-speaker/multi-transducer manners known in the art.

For example, the amplifier 602 may use the executed audio file data to drive voice coil(s) in the tactile transducers 204 to cause the voice coil(s) to exert a force on both a weight element and the base 202 of the tactile transducer device(s) 200 to transmit a force to the foundation element(s) 102a and produce the tactile response that is transmitted through the foundation 100 to the mattress 702 and the patient 704. In another example, the amplifier 602 may use the executed audio file data to drive linear actuator(s) in the tactile transducer device(s) 200 to cause the linear actuator(s) to exert a force on both the ground and the base 202 of the tactile transducer device(s) 200 to transmit a force to the foundation elements 102a to produce the tactile response that is transmitted through the foundation 100 to the mattress 702 and the patient 704. In different embodiments, the amplifier may include a “volume” or “intensity” control that allows the patient (or treatment administrator) to adjust the intensity of the tactile response at block 506 of the method 500. In some embodiments, the tactile transducer device(s) 200 may also produce a sound response from the foundation 100 and/or other components of the system that is audible by a patient. In some embodiments, a patient may attach headphones to the computing device 400 or amplifier 502 in order to directly listen to the audio file being used to drive the tactile transducer devices 200. For example, a patient may wirelessly connect headphones to the computing device 400 or amplifier 502 in order to listen to the audio file being used to drive the tactile transducer devices 200, and it has been found that treatment using such wireless headphones may be more comfortable for patients relative to wired headphones (although wired headphones will fall within the scope of the present disclosure as well.)

In some embodiments, the audio file includes a binaural audio soundtrack that is used to drive a subset of the plurality of tactile transducer devices 200 differently from another subset of the plurality of tactile transducer devices 200. For example, in experimental embodiments, discussed below, a binaural audio soundtrack was used to drive a first subset of the plurality of tactile transducer devices 200 with a 256 hertz sine wave that was blended with a 128 hertz sine wave, while driving a second subset of the plurality of tactile transducer devices 200 with a 246 hertz sine wave that was blended with a 118 hertz sine wave, and the binaural audio soundtrack operated to ramp the blended 246 hertz sine wave/118 hertz sine wave that was used to drive the second subset of the plurality of tactile transducer devices 200 down to a 252 hertz sine wave blended with a 124 hertz sine wave over 25 minutes. Following the 25 minutes, the first subset of the plurality of tactile transducer devices 200 were driven with the blended 256 hertz sine wave/128 hertz sine wave while the second subset of the plurality of tactile transducer devices 200 were driven with the blended 252 hertz sine wave/124 hertz sine wave for 26 minutes, after which the binaural audio soundtrack ended in some experimental embodiments, or was repeated in other experimental embodiments.

In some embodiments, the audio file includes an isochronic tone soundtrack that is used to drive the tactile transducer device(s) 200. Isochronic tones are audio stimuli used in brainwave entrainment processes. In some embodiments, the isochronic tones used in the systems and methods of the present disclosure are regular beats of a single tone emitted at regular intervals. In some embodiments, the isochronic tones used in the systems and methods of the present disclosure may be adjusted in volume or intensity in an evenly-spaced manner to provide a pulse effect through the audio file to drive the tactile transducer device(s) 200.

In some embodiments, the audio file includes a music soundtrack that is used to drive the tactile transducer device(s) 200. In experimental embodiments, a violin was used to create the music soundtrack in the audio file used during block 506 of the method 500. In one experimental embodiment, a chord of A Minor was blended with sounds (e.g., sounds of falling water) from the Omnisphere® virtual instrument available from Spectrasonics Virtual Instruments of Los Angeles, Calif.

In some experimental embodiments, the audio file included each of a binaural audio soundtrack, an isochronic tone soundtrack, and a music soundtrack. However, while specific examples of each of the binaural audio soundtrack, the isochronic tone soundtrack, and the music soundtrack have been provided above, a wide variety of different binaural audio soundtracks, isochronic tone soundtracks, and/or music soundtracks may be provided on the audio file while remaining within the scope of the present disclosure. In experimental embodiments, the use at block 506 of the method 500 of audio files that include a binaural audio soundtracks and isochronic tone soundtracks have shown to provide significant benefits in the treatment of several patient conditions, a few of which are discussed below. However, preliminary experimental embodiments have shown that the use of audio files that include only music soundtracks (i.e., a patients selected music has been used in some experimental embodiments) provide some benefits as well. For example, rock music files, classical music files, electronic music files, and pop music files have been found to be beneficial in use with the systems and methods of the present disclosure.

In some experimental embodiments, the method 500 was used to treat patients suffering from autism, and specifically to treat sleep disorder symptoms of child patients suffering from autism. As such, autism patients were positioned on the tactile transducer treatment system/support system at block 504 of the method 500, and the tactile transducers were driven using an audio file to produce a tactile response at block 506. In some embodiments, the tactile transducer treatment systems and methods of the present disclosure were used on autism patients with sleep issues, and were found to increase the ability to fall asleep and stay asleep. In some embodiments, the tactile transducer treatment systems and methods of the present disclosure were used on autism patients without sleep issues, but with sensory and anxiety issues, and was found to increase relaxation in the autism patients.

The systems and methods of the present disclosure provide for the relaxation of skeletal muscles through mechanical and neurologic means by stimulating the muscle cells with vibration, particularly using the low isochronic tones discussed above, to relax the muscles cells. When the spindle cells in the muscle are stimulated, they signal the A-1 Alpha motor neuron to decrease its contraction strength, thus inhibiting muscle spasticity and contraction, causing an overall relaxation of the muscles being stimulated. The systems and methods of the present disclosure also provide for pain gating through vibratory stimulation of large sensory nerves to inhibit signals from smaller nerves carrying noxious stimuli. This pain gating effect produces a reduction in noxious stimulation of the central nervous system (CNS) and decreases sympathetic tone. The deactivation of the sympathetic nervous system enhances the function of the parasympathetic nervous system, a phenomenon is called the relaxation reflex. The systems and methods of the present disclosure produce a profound effect on the Autonomic Nervous System (ANS) of patients through the resonance technology utilizing the binaural audio and isochronic tones delivered to the patient. At least partly due to the multimodal stimulation of the relaxation reflex, the systems and methods of the present disclosure allows relative parasympathetic dominance in the ANS, thereby enhancing proper homeostatic control of the body. Sympathetic dominance of the ANS over a period of time can lead to exhaustion of vital resources, dysautonomia, and dysregulatory diseases. This type of imbalance is prevalent in populations who have or have had exposure to high levels of stress or whose inherent neurological structure has a higher degree of sympathetic dominance. systems and methods of the present disclosure restore balance in the ANS by disarming the fight-or-flight response through mechanical, neuromuscular and neurological means.

Based on the experimental embodiments with autism patients, the Applicants believe that the method 500 may be effectively used to treat patients suffering from ADD, and specifically to treat sleep disorder symptoms of child patients suffering from ADD. As such, ADD patients may be positioned on the tactile transducer treatment system/support system at block 504 of the method 500, and the tactile transducers may be driven using an audio file to produce a tactile response at block 506. In some embodiments, the tactile transducer treatment systems and methods of the present disclosure may be used on ADD patients with sleep issues, and is expected to increase the ability to fall asleep and stay asleep. In some embodiments, the tactile transducer treatment systems and methods of the present disclosure may be used on ADD patients without sleep issues, but with sensory and anxiety issues, and is expected to increase relaxation in the ADD patients.

Based on the experimental embodiments with autism patients, the Applicants believe that the method 500 may be effectively used to treat patients suffering from ADHD, and specifically to treat sleep disorder symptoms of child patients suffering from ADHD. As such, ADHD patients may be positioned on the tactile transducer treatment system/support system at block 504 of the method 500, and the tactile transducers may be driven using an audio file to produce a tactile response at block 506. In some embodiments, the tactile transducer treatment systems and methods of the present disclosure may be used on ADHD patients with sleep issues, and is expected to increase the ability to fall asleep and stay asleep. In some embodiments, the tactile transducer treatment systems and methods of the present disclosure may be used on ADHD patients without sleep issues, but with sensory and anxiety issues, and is expected to increase relaxation in the ADHD patients.

In some experimental embodiments, the method 500 was used to treat patients suffering from bet wetting. As such, bet wetting patients were positioned on the tactile transducer treatment system/support system at block 504 of the method 500, and the tactile transducers were driven using an audio file to produce a tactile response at block 506. In some embodiments, the tactile transducer treatment systems and methods of the present disclosure were found to reduce the occurrence of bed wetting. Preliminary results suggest that the tactile transducer treatment systems and methods of the present disclosure operate to relax the nervous system of the bed wetting patients such that sensory information utilized in the control of bodily functions may be transmitted in the patient, and possibly to relax the vagus nerve in bed wetting patients so that it may function normally to regulate the patient systems that operate to produce bed wetting.

In some experimental embodiments, the method 500 was used to treat patients suffering from PTSD. As such, PTSD patients were positioned on the tactile transducer treatment system/support system at block 504 of the method 500, and the tactile transducers were driven using an audio file to produce a tactile response at block 506. In some embodiments, the tactile transducer treatment systems and methods of the present disclosure were used on PTSD patients with sleep issues, and were found to increase the ability to fall asleep and stay asleep. In some embodiments, the tactile transducer treatment systems and methods of the present disclosure were used on PTSD patients without sleep issues, but with sensory and anxiety issues, and was found to increase relaxation in the PTSD patients. In some embodiments, PTSD patients were instructed to perform a first mediation exercise prior to and/or while using the tactile transducer treatment systems and methods of the present disclosure, and to perform a second meditation exercise while and/or subsequent to using the tactile transducer treatment systems and methods of the present disclosure. In those embodiments, the first meditation exercise was accompanied by the performance of block 506 of the method using audio files with a first meditation soundtrack, a binaural audio soundtrack, an isochronic tone soundtrack, and a first music soundtrack, and was found to alleviate stress and create wellbeing in the PTSD patients while leaving those PTSD patients awake, while the second meditation exercise was accompanied by the performance of block 506 of the method using audio files with a second meditation soundtrack (i.e., different from the first meditation soundtrack), the binaural audio soundtrack, the isochronic tone soundtrack, and a second music soundtrack (i.e., different from the first music soundtrack) and was found to transition the PTSD patient to sleep. In some experimental embodiments, the first music soundtrack included 3 bars E Minor, 1 bar D Minor repeated, while the second music soundtrack included 4 bars C Major, 4 bars A Minor repeated. Preliminary results suggest that the tactile transducer treatment systems and methods of the present disclosure reduce stress and create a heightened receptivity to the meditation exercises discussed above that increase their effectiveness. Incorporation of the meditation soundtrack into the audio file used in the systems and methods of the present disclosure allow the patient's body to relax and the meditation to be more effective. Guided imagery and meditation with the systems and methods of the present disclosure have all shown significant effects on physiologic relaxation, through stimulation of the relaxation reflex discussed above. Current theories assert that the suggestions given to the patient allow the mind to enhance afferent and efferent signal gating, effectively reducing the sensations perceived by the body. Furthermore, those suggestions have been found to increase the relative dominance of the right temporal lobe of the brain and the parasympathetic nervous system, allowing for an enhanced imaginative experience and diminished stress response

Based on the experimental embodiments with autism patients, the Applicants believe the method 500 may be used to treat patients suffering from muscular disorders such as Parkinson's Disease and Cerebral Palsy. As such, muscular disorder patients may be positioned on the tactile transducer treatment system/support system at block 504 of the method 500, and the tactile transducers may be driven using an audio file to produce a tactile response at block 506. In some embodiments, the tactile transducer treatment systems and methods of the present disclosure may be used on muscular disorder patients with sleep issues, and is expected to increase the ability to fall asleep and stay asleep. In some embodiments, the tactile transducer treatment systems and methods of the present disclosure may be used on muscular disorder patients without sleep issues, but with sensory and anxiety issues, and is expected to increase relaxation in the muscular disorder patients.

In some experimental embodiments, the method 500 was used to treat patients suffering from a variety of conditions that necessitate a massage (i.e., massage patients). Preliminary results suggest that the tactile transducer treatment systems and methods of the present disclosure put the massage patients into an emotional and/or physical state that allows for greater success in the massage treatment by the treatment provider.

Thus, systems and methods have been described that utilize one or more tactile transducers mounted to a bed mattress foundation to produce a tactile response that is transmitted through a mattress to a patient to treat a variety of patient sleep and/or relaxation disorders. The use of an audio file to drive the one or more tactile transducers has been found to have specific and particular benefits for patients suffering from sleep or relaxation symptoms, and in particular, the use of an audio file that includes a binaural audio recording of isochronic tones has provided promising results in a variety of cases. However, while extensive discussion of binaural audio recordings of isochronic tones has been provided, preliminary experimental embodiments have found some success using audio files that include music to drive the one or more tactile transducers (e.g., a patients favorite music has been used at block 506 of the method 500 and provided promising results in some subsets of patients). As such, the use of any type of recorded music in the audio file is also envisioned as falling within the scope of the present disclosure. The systems and methods of the present disclosure are presented as a new and innovative way to treat a plurality of sleep and relaxation issues resulting from any of a variety of patient conditions.

In specific experimental embodiments conducted at the Center for Autism in the Cleveland Clinic Children's Hospital for Rehabilitation in Cleveland, Ohio, the following data was collected for the purpose of evaluation of the systems and methods of the present disclosure with regard to the treatment of autistic children for sleep disorder. The testing included a crossover within-subjects design with a patient population of children clinically diagnosed with autism having behavioral issues and an extreme difficulty following standardized protocols. Actigraphy (wrist-worn devices used to measure motion) was used to objectively measure sleep, and the following data was obtained:

Wake Time (%)

| | Time 1 | Time 2 | |
|---|---|---|---|
| | M (SD) | M (SD) | F (p) |
| Mattress Off First | 18.2% (6.5) | 16.1% (7.5) | 7.79 (.013) |
| Mattress On First | 15.4% (5.5) | 16.4% (4.9) | |

The expected pattern was observed with lower percentage of time awake when the mattress was on, regardless of the order of mattress activation. The pattern was strong and statistically significant. Percentage of time awake was ˜1-2% better in the mattress on condition.

Sleep Efficiency (%)

| | Time 1 | Time 2 | |
|---|---|---|---|
| | M (SD) | M (SD) | F (p) |
| Mattress Off First | 78.8% (8.2) | 80.7% (9.7) | 7.94 (.012) |
| Mattress On First | 81.1% (6.4) | 79.1% (6.7) | |

The expected pattern was observed with a higher sleep efficiency percentage when the mattress was on, regardless of the order of mattress activation. The pattern was strong and statistically significant. Percentage of time awake was ˜1-2% better in the mattress on condition.

The data above shows statistically significant effects (p<0.05) in two areas important to this patient population: wake time (the percentage of time spent awake) and sleep efficiency (a global objective measure of sleep quality). While further studies are being conducted, the Applicants of the present disclosure submit the preliminary studies discussed above as an illustration of the positive results that are currently being achieved using the novel systems and methods described herein in the treatment of autism, and expect further positive results in the treatment of the other disorders discussed above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A tactile transducer treatment system, comprising:
a foundation that is configured to support a mattress;
at least one tactile transducer device that is mounted to the foundation;
a processing system that coupled to the at least one tactile transducer device;
a memory system that is coupled to the processing system and that includes instructions that, when executed by the processing system, cause the processing system to provide a treatment engine that is configured to:
drive the at least one tactile transducer using an audio file that includes a binaural audio soundtrack and an isochronic tone soundtrack, wherein the driving of the at least one tactile transducer produces a tactile response in the foundation.

2. The tactile transducer treatment system of claim 1, further comprising:
an amplifier that is coupled between the at least one tactile transducer and the processing system.

3. The tactile transducer treatment system of claim 1, further comprising:
a mattress that is positioned on the foundation, wherein the mattress transmits the tactile response to the driving of the at least one tactile transducer.

4. The tactile transducer treatment system of claim 1, wherein the at least one tactile transducer includes a plurality of a tactile transducers.

5. A method for treating autism, comprising:
providing a support system including at least one tactile transducer;
positioning an autism patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the autism patient.

6. A method for treating attention deficit disorder (ADD), comprising:
providing a support system including at least one tactile transducer;
positioning an ADD patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the ADD patient.

7. A method for treating attention deficit hyperactivity disorder (ADHD), comprising:
providing a support system including at least one tactile transducer;
positioning an ADHD patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the ADHD patient.

8. A method for treating bed wetting, comprising:
providing a support system including at least one tactile transducer;
positioning a bed wetting patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the bed wetting patient.

9. The method of claim 8, wherein the driving the at least on tactile transducer using the audio file that includes a binaural audio soundtrack and an isochronic tone soundtrack is configured to relax the nervous system of the bed wetting patient such that sensory information utilized in the control of bodily functions may be transmitted.

10. The method of claim 9, wherein the driving the at least on tactile transducer using the audio file that includes a binaural audio soundtrack and an isochronic tone soundtrack is configured to relax the vagus nerve in the bed wetting patient.

11. A method for treating post-traumatic stress disorder (PTSD), comprising:
providing a support system including at least one tactile transducer;
positioning a PTSD patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the PTSD patient.

12. The method of claim 11, further comprising:
performing a first meditation exercise by the PTSD patient while driving the at least on tactile transducer using the audio file that includes a binaural audio soundtrack and an isochronic tone soundtrack.

13. The method of claim 12, further comprising:
performing a second meditation exercise by the PTSD patient while driving the at least on tactile transducer using the audio file that includes a binaural audio soundtrack and an isochronic tone soundtrack.

14. A method for providing a massage, comprising:
providing a support system including at least one tactile transducer;
positioning a massage patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the massage patient.

15. A method for providing sleep, comprising:
providing a support system including at least one tactile transducer;
positioning a sleep patient on the support system; and
driving the at least on tactile transducer using an audio file that includes a binaural audio soundtrack and an isochronic tone soundtrack, wherein the driving of the at least one tactile transducer produces a tactile response in the support system that is transmitted to the sleep patient.

16. The method of claim 15, further comprising:
providing a listening device on the sleep patient; and
playing the audio file using the listening device.

17. The method of claim 16, wherein the listening device is wireless.

18. The method of claim 16, wherein the playing of the audio file using the listening device creates a brainwave entrainment process in the sleep patient.
